(19) United States
(12) Patent Application Publication
(10) Pub. No.: US 2025/0055578 A1
(43) Pub. Date: Feb. 13, 2025

(54) MONITORING AND TESTING PREDICTION PERFORMANCE

(71) Applicant: Nokia Technologies Oy, Espoo (FI)

(72) Inventors: Wolfgang ZIRWAS, Munich (DE); Fahad Syed Muhammad, Massy (FR); Bharath Ramesh Kashyap, Bangalore (IN); Dimitri Gold, Espoo (FI)

(21) Appl. No.: 18/775,456

(22) Filed: Jul. 17, 2024

(30) Foreign Application Priority Data
Aug. 9, 2023 (IN) 202341053449

(51) Int. Cl. H04B 17/318; H04B 17/373; H04L 5/00

(52) U.S. Cl. CPC H04B 17/318; H04B 17/373; H04L 5/0048

(57) ABSTRACT

Embodiments of the present disclosure relate to apparatuses, methods, devices and computer readable storage medium for monitoring and testing prediction performance. The method comprising: receiving, at a first apparatus from a second apparatus, a first set of reference signals and a second set of reference signals different from the first set of reference signals; generating a predicted result for a first time period based on the first set of reference signals; generating a measured result for the first time period based on the second set of reference signals; and transmitting the predicted result and the measured result to the second apparatus.

### FIELDS

Various example embodiments of the present disclosure generally relate to the field of telecommunication and in particular, to apparatuses, methods, devices and computer readable storage medium for monitoring and testing prediction performance.

### BACKGROUND

Several technologies have been proposed to improve communication performances. For example, communication devices may employ an artificial intelligence (AI)/ML model to improve communication qualities. The AI/ML model can be applied to different scenarios. Therefore, performances of the AL/ML model are an importance issue.

### SUMMARY

In a first aspect of the present disclosure, there is provided a first apparatus. The first apparatus comprises at least one processor; and at least one memory storing instructions that, when executed by the at least one processor, cause the first apparatus to: receive, from a second apparatus, a first set of reference signals and a second set of reference signals different from the first set of reference signals; generate a predicted result for a first time period based on the first set of reference signals; generate a measured result for the first time period based on the second set of reference signals; and transmit the predicted result and the measured result to the second apparatus.

In a second aspect of the present disclosure, there is provided a second apparatus. The second apparatus comprises at least one processor; and at least one memory storing instructions that, when executed by the at least one processor, cause the second apparatus to: transmit, to a first apparatus, a first set of reference signals and a second set of reference signals different from the first set of reference signals; receive, from the first apparatus, a predicted result for a first time period and a measured result for the first time period, wherein the predicted result is based on the first set of reference signals, and the measured result is based on the second set of reference signals; and determine a prediction performance based on the predicted result and the measured result.

In a third aspect of the present disclosure, there is provided a method. The method comprises: receiving, from a second apparatus, a first set of reference signals and a second set of reference signals different from the first set of reference signals; generating a predicted result for a first time period based on the first set of reference signals; generating a measured result for the first time period based on the second set of reference signals; and transmitting the predicted result and the measured result to the second apparatus.

In a fourth aspect of the present disclosure, there is provided a method. The method comprises: transmitting, to a first apparatus, a first set of reference signals and a second set of reference signals different from the first set of reference signals; receiving, from the first apparatus, a predicted result for a first time period and a measured result for the first time period, wherein the predicted result is based on the first set of reference signals, and the measured result is based on the second set of reference signals; and determining a prediction performance based on the predicted result and the measured result.

In a fifth aspect of the present disclosure, there is provided a first apparatus. The first apparatus comprises means for receiving, from a second apparatus, a first set of reference signals and a second set of reference signals different from the first set of reference signals; means for generating a predicted result for a first time period based on the first set of reference signals; means for generating a measured result for the first time period based on the second set of reference signals; and means for transmitting the predicted result and the measured result to the second apparatus.

In a sixth aspect of the present disclosure, there is provided a second apparatus. The second apparatus comprises means for transmitting, to a first apparatus, a first set of reference signals and a second set of reference signals different from the first set of reference signals; means for receiving, from the first apparatus, a predicted result for a first time period and a measured result for the first time period, wherein the predicted result is based on the first set of reference signals, and the measured result is based on the second set of reference signals; and means for determining a prediction performance based on the predicted result and the measured result.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example signaling chart for monitoring or testing prediction performance according to some example embodiments of the present disclosure;

FIG. 3A to FIG. 3C illustrates examples of CSI prediction according to some example embodiments of the present disclosure;

FIG. 4 illustrates an example signaling chart for CSI prediction according to some example embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “AI/ML model” may refer to a data driven algorithm that applies AI/ML techniques to generate a set of outputs based on a set of inputs. In the context of the present disclosure, the term “AI/ML model” may be used interchangeably with the terms “model”, “AI model” and “ML model”. The term “AI/ML” may be used interchangeably with the terms “AI” and “ML”.

### Example Environment

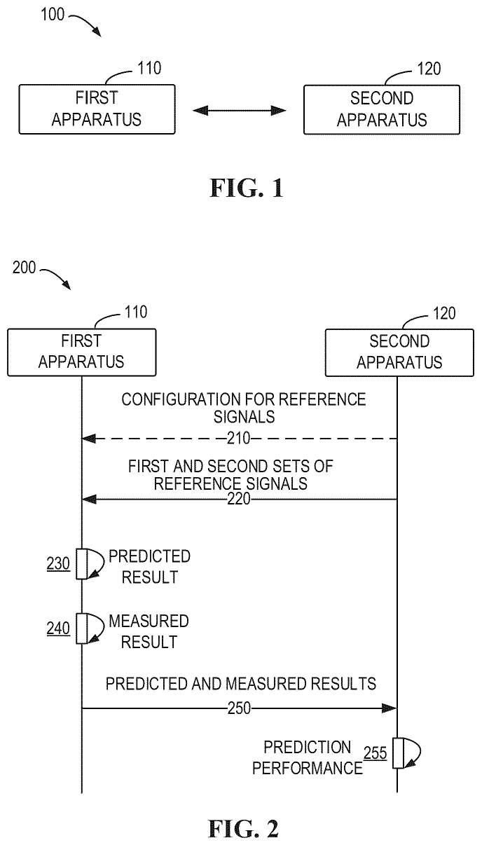

FIG. 1 illustrates an example communication environment 100 in which example embodiments of the present disclosure may be implemented. As shown in FIG. 1, the communication network 100 may include a first apparatus 110 and a second apparatus 120. The first apparatus 110 may communicate with the second apparatus 120. An AI/ML model may be deployed at the first apparatus 110. The AI/ML model may be used for any suitable use cases or to implement any suitable functionalities, for example but not limited to, channel state information (CSI) prediction, beam management (also referred to as beam prediction), positioning, etc. Monitoring or testing the performance of the AL/ML model may be needed.

It is to be understood that the number of second apparatus and first apparatus shown in FIG. 1 is given for the purpose of illustration without suggesting any limitations. The communication network 100 may include any suitable number of second apparatus and first apparatus.

In some example embodiments, the first apparatus 110 may comprise a device under test (DUT), and the second apparatus 120 may comprise a test equipment (TE). For example, the AI/ML model at the first apparatus 110 may need to be tested.

In some example embodiments, the first apparatus 110 may comprise a terminal device (for example, a UE), and the second apparatus 120 may comprise a network device (for example, a gNB). For example, the performance of the AI/ML model may need to be monitored.

In the following, for the purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device and the second apparatus 120 is a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, AI/ML for New Radio (NR) air interface is now studied in 3rd Generation Partnership Project (3GPP). One of the objectives of the study is to cover the interoperability and testability aspect of the newly defined AI/ML enabled features. In this aspect, studies on use case may include for example requirements and testing frameworks to validate AI/ML based performance enhancements, ensuring that UE and gNB with AI/ML meet or exceed the existing minimum requirements if applicable, considering the need and implications for AI/ML processing capabilities definition.

AI/ML enabled CSI feedback enhancement is one of the selected use cases for study. This use case is a potential use case to be selected for new release work item on AI/ML. One of the selected sub use cases for CSI feedback enhancement is CSI prediction.

Some mechanisms have been proposed to address the aspects of inference performance evaluation for different selected use cases for AI/ML enabled features. CSI prediction accuracy is one of the test metrics/key performance indicators (KPIs) selected for further study. Therefore, testing mechanism for CSI prediction accuracy is a topic of very high interest in 3GPP.

Metrics for CSI requirements/tests are to be defined. Regarding metrics for CSI requirements/tests for model inference performance testing, a possible test metric may be throughput, for example, an absolute throughput or relative throughput. If throughput is not applicable or significant, other test metrics are not precluded.

For CSI prediction use case as an example, CSI prediction accuracy is one of the test metrics currently under consideration for inference performance verification. Therefore, it is important to find a test mechanism to verify CSI prediction accuracy. One of the main challenges in such verification is the extraction of the ground truth.

Secondly, if the ground truth is known at a first apparatus side (e.g., DUT), then a mechanism is needed as well to transport it to a second apparatus (e.g., TE).

The main steps of an example test framework include four steps which are as described below. At step 1: the requirements of the considered ML based CSI prediction model may be identified. At step 2, the established requirements and assumptions in step 1 are mapped to the test. The DUT is configured to measure the CSI at some regular intervals, and this interval may be significantly higher than the actual CSI reporting frequency to reduce the overhead and computational complexity at the DUT side. It is made sure that these measurement intervals are overlapped with the CSI prediction horizon to capture the ground truth for the corresponding predicted value of CSI. At step 3, the DUT stores the corresponding measured and predicted CSI and reports both values to TE, where the comparison of the predicted values with the reported ground truth takes place. At step 4, the test results are analyzed, and the performance is derived following selected KPIs (e.g., 90% percentile of achieved accuracy).

For the above mentioned framework, there is the underlying assumption that the DUT is operating honestly and not faking any ground truth monitoring reports. However, there can be a malicious/rogue DUT which might just report ground truth CSI reports, which can closely match the reported predicted CSI without really estimating the radio channel. Thereby, it might pass the test of the framework without even implementing any channel predictor or any ground truth CSI estimator.

Similarly, the use case of AI/ML based CSI enhancements includes the subtopic of CSI monitoring, which is, for example, needed for the life cycle management of ML models. In this case, the UE might monitor the radio channel relative to its predicted radio channel and reports its monitoring results to the gNB. Life cycle management (LCM) related decisions such as ML model updating, switching or fallback might then rely on the monitored ground truth CSI that is reported. Therefore, it would be beneficial for the gNB to ensure that correct CSI is reported by the UE and know the achieved accuracy of the CSI reported by the UE.

### Work Principle and Example Signaling for Communication

According to some example embodiments of the present disclosure, there is provided a solution for monitoring and testing prediction performance. In this solution, a first apparatus may receive, from a second apparatus, a first set of reference signals and a second set of reference signals (RSs) different from the first set of reference signals. The first apparatus may generate a predicted result for a first time period based on the first set of reference signals. The first apparatus may generate a measured result for the first time period based on the second set of RSs. The first apparatus may transmit the predicted result and the measured result to the second apparatus.

In this way, a framework is provided to generate the predicted result and the measured result at the first apparatus and to transmit the results to the second apparatus for testing or monitoring purpose. According to embodiments of the present disclosure, the first apparatus (for example, a rogue UE or DUT) can be prevented from reporting fake prediction reports or ground truth reports that are very close to reality, since the first apparatus does not know the second set of RSs. Instead, the first apparatus is forced to perform the prediction based on the regular RSs and to estimate the ground truth result. In this way, a true performance of the AI/ML model can be derived.

Example embodiments of the present disclosure will be described in detail below with reference to the accompanying drawings.

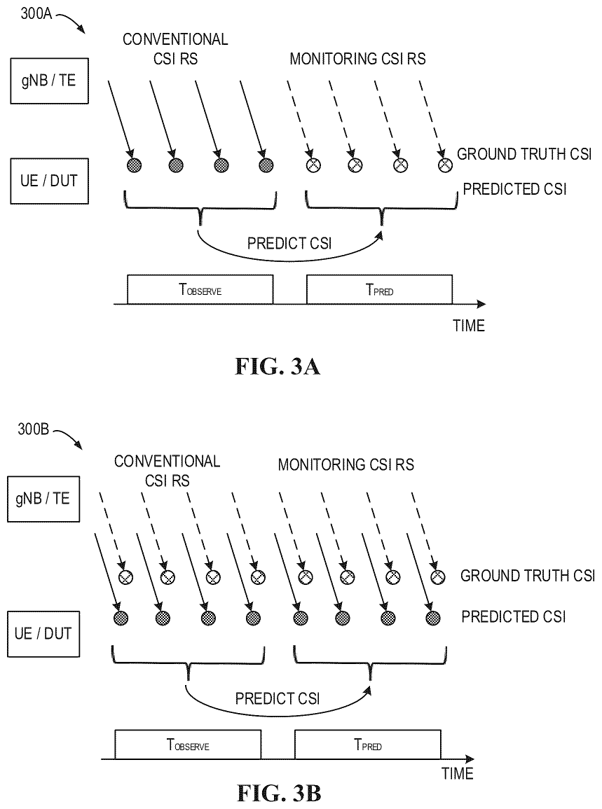

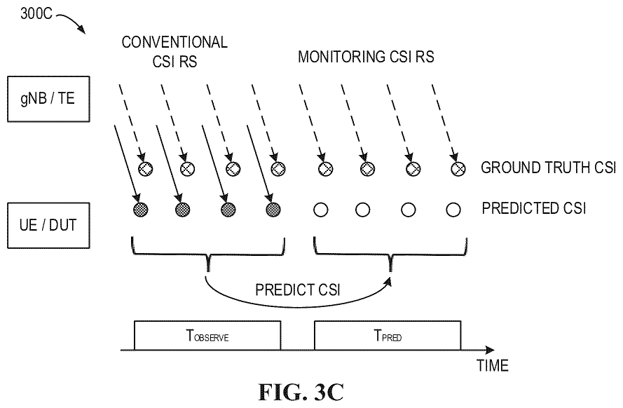

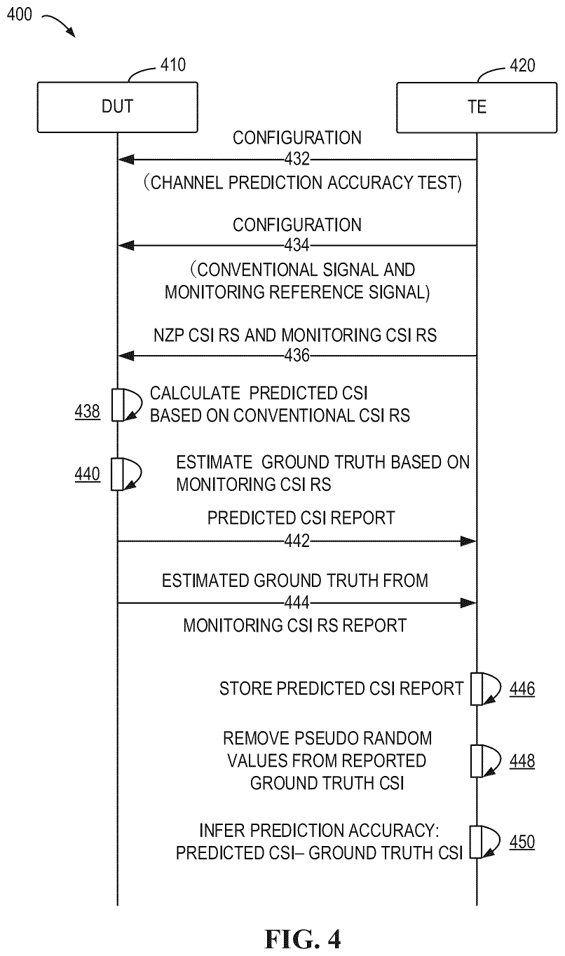

Reference is now made to FIG. 2, which illustrates a signaling chart 200 for monitoring and testing prediction performance according to some example embodiments of the present disclosure. As shown in FIG. 2, the signaling chart 200 involves the first apparatus 110 and the second apparatus 120. The signaling chart 200 may be applicable for any suitable AI/ML use cases. For example, various AI/ML use cases may include but not limited to CSI prediction, beam management, positioning, etc. In the following, some example embodiments are described by taking the CSI prediction as an example, for example with reference to FIG. 3A to FIG. 4. However, it is to be understood that this is merely an example without any limitation, and the concept described with respect the CSI prediction may be applied to another AI/ML use cases.

For the purpose of discussion, reference is made to FIG. 1 to describe the signaling chart 200. As shown in FIG. 2, the first apparatus 110 may receive (220) a first set of RSs and a second set of RSs from the second apparatus 120. The second set of RSs are different from the first set of RSs. The first set of RSs may be conventional RSs for measurement, and may be also referred to as conventional RSs hereinafter. The second set of RSs may be RSs different from the conventional RSs for the purpose of monitoring or testing. The second set of RSs may be also referred to as monitoring RSs merely for purpose of discussion without any limitation. In some example embodiments, in the use case of CSI prediction, the first set of RSs may be also referred to as regular or conventional CSI RSs, and the second set of RSs may be also referred to as monitoring CSI RSs.

In some example embodiments, before receiving the first set and second set of RSs, the first apparatus 110 may receive (210) a configuration for the RSs from the second apparatus 120.

In some example embodiments, before transmitting, the second apparatus 120 may precode the second set of RSs with a signal characteristic which is unknown to the first apparatus 110. In this way, the first apparatus 110 may not know about the real ground truth.

The signal characteristic may be any suitable characteristic of the second set of RSs. For example, the signal characteristic may comprise a pseudo random phase and/or a pseudo random amplitude. In this example embodiments, the second set of RSs may be transmitted with the pseudo random phase and/or the pseudo random amplitude. In this way, the first apparatus 110 does not directly know the ground truth result as the ground truth result is the superposition of the real-world radio channel as well as the pseudo random phases/amplitudes of the monitoring RSs. Only the second apparatus 120 can reconstruct the estimated ground truth CSI since only the second apparatus 120 knows the pseudo random values used for the monitoring RSs, which can then easily be subtracted from the reported ground truth values of the DUT.

Continuing with the chart 200, the first apparatus 110 may generate (230) a predicted result for a first time period based on the first set of RSs. For example, the AI/ML model may be used to generate the predicted result based on measurements performed on the first set of RSs. The first apparatus 110 may generate (240) a measured result for the first time period based on the second set of RSs. The measured result may be generated by measuring the second set of RSs within the first time period. The first time period may be any suitable time period with any suitable length. For example, in the use case of CSI prediction, the first time period may be a prediction time window.

The specific kind of the predicted and measured results may depend on the specific AI/ML use case. For example, in the use case of CSI prediction, the predicted result may include predicted CSI for one or more prediction time instances within the prediction time window. It is to be understood that one prediction time instance is possible. Accordingly, the measured result may include CSI for the one or more prediction time instances determined based on measurements on the monitoring CSI RSs.

Then, the first apparatus 110 may transmit (250) the predicted result and the measured result to the second apparatus 120. The predicted result and measured result may be transmitted in the same or different signaling.

Accordingly, the second apparatus 120 may receive the predicted result and measured results from the first apparatus and determine (255) a prediction performance based on the predicted result and the measured result. The prediction performance may be evaluated by any suitable KPI, for example, a prediction accuracy. It is to be noted that if the predicted result is derived by using the AI/ML model, the prediction performance may represent the performance of the AI/ML model.

In some example embodiments, if the second set of RSs are precoded with the signal characteristic unknown to the first apparatus, the second apparatus 120 may update the measured result based on the signal characteristic. In other words, an impact of the signal characteristic on the real ground truth shall be subtracted from the measured result reported from the first apparatus 110. For example, the pseudo random phases and/or the pseudo random amplitudes may be subtracted from the measured result.

The updated measured result is the ground truth. Then, the second apparatus 120 may generate the prediction performance by comparing the updated measured result and the predicted result.

An example signaling chart 200 for monitoring or testing an AI/ML model is described above. Some example embodiments regarding the configurations of the first and second sets of RSs are now described.

In some example embodiments, the first set of RSs may be received within a second time period. The second set of RSs may be received within the first time period. In some example embodiments, the second time period may be different from the first time period. For example, these two time periods may be not overlapped with each other in time domain. For another example, these two windows may be at least partially overlapped in time domain. In the use case of CSI prediction, the second time period may be an observation time window.

An example taking CSI prediction for instance is now described with reference to FIG. 3A. FIG. 3A illustrates an example of CSI prediction according to some example embodiments of the present disclosure. As shown, the first apparatus 110 may be a UE or a DUT, and the second apparatus 120 may be a gNB or a TE. Take the UE and gNB for instance. The gNB transmits conventional CSI RSs (shown by solid lines) within observation time window, i.e., T_{observe} and transmits monitoring CSI RSs (shown by dashed lines) in a prediction time window, i.e., T_{pred}. T_{observe} is earlier than and close to T_{pred}.

In FIG. 3A, the predicted CSI is generated based on the observation over T_{observe} conventional CSI RSs, while the ground truth CSI estimation for T_{pred} is determined based on the monitoring CSI RSs.

The monitoring CSI RSs may be transmitted with a pseudo random phase and potentially also a pseudo random amplitude. For that reason, the UE does not directly know the ground truth CSI as it is the superposition of the real-world radio channel as well as the pseudo random phases/amplitudes of the monitoring CSI RSs. Only the gNB may reconstruct the estimated ground truth CSI as only the gNB has the pseudo random values used for the monitoring CSI RSs, which may then easily be subtracted from the reported ground truth CSI of the UE.

In this way, the UE cannot fake the ground truth CSI reports without really estimating the ground truth CSI for the monitoring CSI RSs. In addition, a rogue UE cannot report artificially improved ground truth CSI, which might be aligned with the reported predicted CSI as the UE does not know the ground truth CSI, nor the pseudo random values used for the monitoring CSI RSs.

It should be understood that the present disclosure need not be specific to CSI prediction, which is taken as an example here, but can also be used for other use cases such as beam management and positioning.

Alternative implementations to the above described one may be considered. Alternatively, or in addition, in some example embodiments, the first set of RSs may be allocated with a first resource element, and the second set of RSs may be allocated with a second resource element which is different from the first resource element.

An example still taking CSI prediction for instance is now described with reference to FIG. 3B. FIG. 3B illustrates another example of CSI prediction according to some example embodiments of the present disclosure. Monitoring CSI RSs (shown by dashed lines) transmitted regularly in parallel to the conventional CSI RS (shown by solid lines) may be allocated with different but close by resource elements.

In FIG. 3B, the conventional CSI RSs as well as the monitoring CSI RSs are transmitted in parallel continuously, which would allow the UE to predict the CSI and similarly to estimate the ground truth CSI based on the conventional CSI RSs. The conventional CSI RSs and the monitoring CSI RSs may be, for example, transmitted on two different Antenna Ports (APs). To ensure minimal differences between the radio channel conditions for the APs of the conventional and monitoring CSI RSs, the resource elements of these APs should be allocated to close by resource elements per PRB. For example, the two resource elements are adjacent or close enough to ensure that they go through almost the same radio condition.

Such example embodiments can support more advanced channel estimation and channel prediction implementations.

Alternatively, or in addition, in some example embodiments, the first set of RSs may be transmitted with a zero power within the first time period, and the second set of RSs may be transmitted with a non-zero power (NZP) within the first time period.

For example, a slight variation to the example of FIG. 3B may be made. In the variation, the conventional CSI RSs may be transmitted with zero power for the prediction time window so that the UE may not directly infer the ground truth CSI. Ideally, for the prediction time window, the gNB may not transmit any other signals to the UE, which otherwise might be used in some way for direct ground truth channel estimation.

An example still taking CSI prediction for instance is now described with reference to FIG. 3C. FIG. 3C illustrates another example of CSI prediction according to some example embodiments of the present disclosure. The monitoring CSI RSs (shown by dashed lines) transmitted regularly in parallel to the conventional CSI RSs (shown by solid lines) may be allocated with different but close by resource elements. The conventional CSI RSs may be transmitted with a zero power within the prediction time window while the monitoring CSI RSs may be transmitted with a non-zero power within the prediction time window. In this way, the conventional CSI RSs for the predicted time window can be omitted to avoid the UE to fake the predicted CSI report.

Such example embodiments may be particularly suitable in the case of testing a DUT as well as in the case of quite seldom monitoring events for active UEs.

It is to be noted that FIG. 3A to 3C illustrate the use case of CSI prediction as an example. The concept described above may be applicable to other use cases, for example, beam prediction, positioning, etc. Although in FIG. 3A to 3C, the prediction time window and observation time window are illustrated as examples for the first and second time periods. The first and second time periods may be any suitable time period depending on the use case of the AI/ML model. It is also to be understood that in some use cases, there may be only one time period, for example in the use case of CSI feedback.

To better understand the solution of the present disclosure, an example process for CSI prediction is now described with reference to FIG. 4. FIG. 4 illustrates a signaling chart 400 illustrating an example of CSI prediction according to some example embodiments of the present disclosure. In the chart 400, the DUT 410 is an example of the first apparatus 110 and the TE 420 is an example of the second apparatus 120.

In FIG. 4, the DUT 410 may receive (432) a configuration for a channel prediction accuracy test from the TE 420. In other words, the TE 420 may configure the DUT 410 for channel prediction accuracy test. The DUT 410 may receive (434) a configuration for a conventional RSs and monitoring RSs from the TE 420. Then, the DUT 410 may receive (436) non-zero power (NZP) CSI RSs and monitoring CSI RS from the TE 420.

The DUT 410 may calculate (438) predicted CSI based on conventional CSI RSs. The DUT 410 may estimate (440) ground truth CSI based on monitoring CSI RSs.

The DUT 410 may transmit (442) a report of the predicted CSI to the TE 420 and transmit (444) a report of the estimated ground truth CSI from the monitoring CSI RSs.

The TE 420 may store (446) the report of the predicted CSI. The TE 420 may remove (448) pseudo random values (for example, pseudo random phases and/or pseudo random amplitudes) from reported ground truth CSI. Accordingly, ground truth CSI may be derived. Therefore, the TE 420 may infer (450) the prediction accuracy for example based on a difference between the predicted CSI and the ground truth CSI.

According to those embodiments in the present disclosure, the correct CSI may be reported by a UE/DUT and the accuracy of the CSI reported may be achieved.

### Example Methods

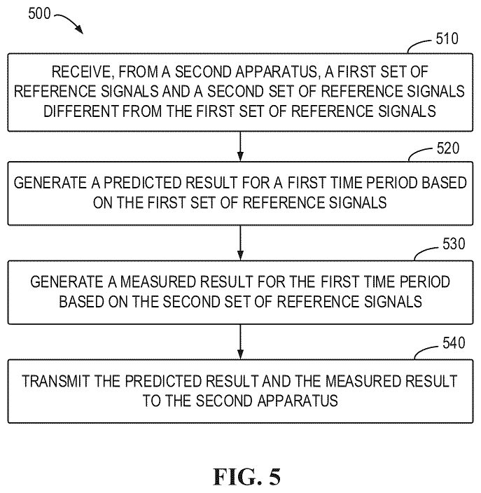

FIG. 5 shows a flowchart of an example method 500 implemented at a first apparatus in accordance with some example embodiments of the present disclosure. For the purpose of discussion, the method 500 will be described from the perspective of the first apparatus 110 in FIG. 1.

At block 510, the first apparatus 110 receives, from a second apparatus 120, a first set of reference signals and a second set of reference signals different from the first set of reference signals.

At block 520, the first apparatus 110 generates a predicted result for a first time period based on the first set of reference signals.

At block 530, the first apparatus 110 generates a measured result for the first time period based on the second set of reference signals.

At block 540, the first apparatus 110 transmits the predicted result and the measured result to the second apparatus 120.

In some example embodiments, the second set of reference signals are precoded with a signal characteristic unknown to the first apparatus.

In some example embodiments, the signal characteristic comprises at least one of: a pseudo random phase, or a pseudo random amplitude.

In some example embodiments, the second set of reference signals are received within the first time period, and the first set of reference signals are received within a second time period different from the first time period.

In some example embodiments, the first set of reference signals are allocated with a first resource element, and the second set of reference signals are allocated with a second resource element different from the first resource element.

In some example embodiments, the first set of reference signals are transmitted with a zero power within the first time period, and the second set of reference signals are transmitted with a non-zero power within the first time period.

In some example embodiments, the first resource element and the second resource element are adjacent within a physical resource block.

In some example embodiments, the first apparatus 110 receives, from the second apparatus, a configuration for the first set of reference signals and the second set of reference signals.

In some example embodiments, the first apparatus 100 comprises a device under test, and the second apparatus 120 comprises a test equipment, or the first apparatus comprises a terminal device, and the second apparatus 120 comprises a network device.

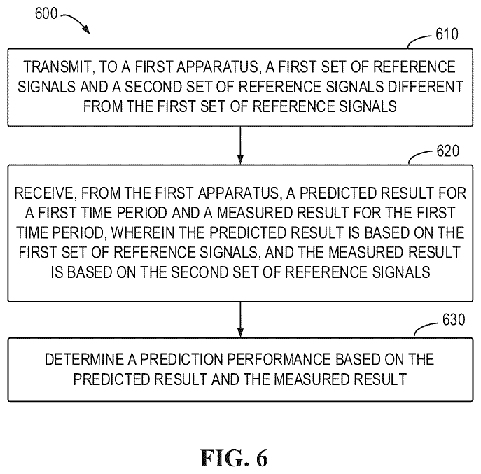

FIG. 6 shows a flowchart of an example method 600 implemented at a second apparatus in accordance with some example embodiments of the present disclosure. For the purpose of discussion, the method 600 will be described from the perspective of the second apparatus 120 in FIG. 1.

At block 610, the second apparatus 120 transmits, to a first apparatus 110, a first set of reference signals and a second set of reference signals different from the first set of reference signals.

At block 620, the second apparatus 120 receives, from the first apparatus 110, a predicted result for a first time period and a measured result for the first time period, wherein the predicted result is based on the first set of reference signals, and the measured result is based on the second set of reference signals.

At block 630, the second apparatus 120 determines a prediction performance based on the predicted result and the measured result.

In some example embodiments, the second apparatus 120 precodes the second set of reference signals with a signal characteristic unknown to the first apparatus 110.

In some example embodiments, the signal characteristic comprises at least one of: a pseudo random phase, or a pseudo random amplitude.

In some example embodiments, the second apparatus 120 updates the measured result based on the signal characteristic; and generating the prediction performance by comparing the updated measured result and the predicted result.

In some example embodiments, the second set of reference signals are transmitted within the first time period, and the first set of reference signals are transmitted within a second time period different from the first time period.

In some example embodiments, the first set of reference signals are allocated with a first resource element, and the second set of reference signals are allocated with a second resource element different from the first resource element.

In some example embodiments, the first set of reference signals are transmitted with a zero power within the first time period, and the second set of reference signals are transmitted with a non-zero power within the first time period.

In some example embodiments, the first resource element and the second resource element are adjacent within a physical resource block.

In some example embodiments, the second apparatus 120 transmits, to the first apparatus 110, a configuration for the first set of reference signals and the second set of reference signals.

In some example embodiments, the first apparatus 110 comprises a device under test, and the second apparatus 120 comprises a test equipment, or the first apparatus 110 comprises a terminal device, and the second apparatus 120 comprises a network device.

### Example Apparatus, Device and Medium

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a first set of reference signals and a second set of reference signals different from the first set of reference signals; means for generating a predicted result for a first time period based on the first set of reference signals; means for generating a measured result for the first time period based on the second set of reference signals; and means for transmitting the predicted result and the measured result to the second apparatus.

In some example embodiments, the second set of reference signals are precoded with a signal characteristic unknown to the first apparatus.

In some example embodiments, the signal characteristic comprises at least one of: a pseudo random phase, or a pseudo random amplitude.

In some example embodiments, the second set of reference signals are received within the first time period, and the first set of reference signals are received within a second time period different from the first time period.

In some example embodiments, the first set of reference signals are allocated with a first resource element, and the second set of reference signals are allocated with a second resource element different from the first resource element.

In some example embodiments, the first set of reference signals are transmitted with a zero power within the first time period, and the second set of reference signals are transmitted with a non-zero power within the first time period.

In some example embodiments, the first resource element and the second resource element are adjacent within a physical resource block.

In some example embodiments, the first apparatus comprises means for receiving, from the second apparatus, a configuration for the first set of reference signals and the second set of reference signals.

In some example embodiments, the first apparatus comprises a device under test, and the second apparatus comprises a test equipment, or the first apparatus comprises a terminal device, and the second apparatus comprises a network device.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 120 in FIG. 1 may comprise means for performing the respective operations of the method 600. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a first set of reference signals and a second set of reference signals different from the first set of reference signals; means for receiving, from the first apparatus, a predicted result for a first time period and a measured result for the first time period, wherein the predicted result is based on the first set of reference signals, and the measured result is based on the second set of reference signals; and means for determining a prediction performance based on the predicted result and the measured result.

In some example embodiments, the second apparatus comprises means for precoding the second set of reference signals with a signal characteristic unknown to the first apparatus.

In some example embodiments, the signal characteristic comprises at least one of: a pseudo random phase, or a pseudo random amplitude.

In some example embodiments, the instructions, when executed by the at least one processor, cause the second apparatus to: means for updating the measured result based on the signal characteristic; and means for generating the prediction performance by comparing the updated measured result and the predicted result.

In some example embodiments, the second set of reference signals are transmitted within the first time period, and the first set of reference signals are transmitted within a second time period different from the first time period.

In some example embodiments, the first set of reference signals are allocated with a first resource element, and the second set of reference signals are allocated with a second resource element different from the first resource element.

In some example embodiments, the first set of reference signals are transmitted with a zero power within the first time period, and the second set of reference signals are transmitted with a non-zero power within the first time period.

In some example embodiments, the first resource element and the second resource element are adjacent within a physical resource block.

In some example embodiments, the second apparatus comprises means for transmitting, to the first apparatus, a configuration for the first set of reference signals and the second set of reference signals.

In some example embodiments, the first apparatus comprises a device under test, and the second apparatus comprises a test equipment, or the first apparatus comprises a terminal device, and the second apparatus comprises a network device.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

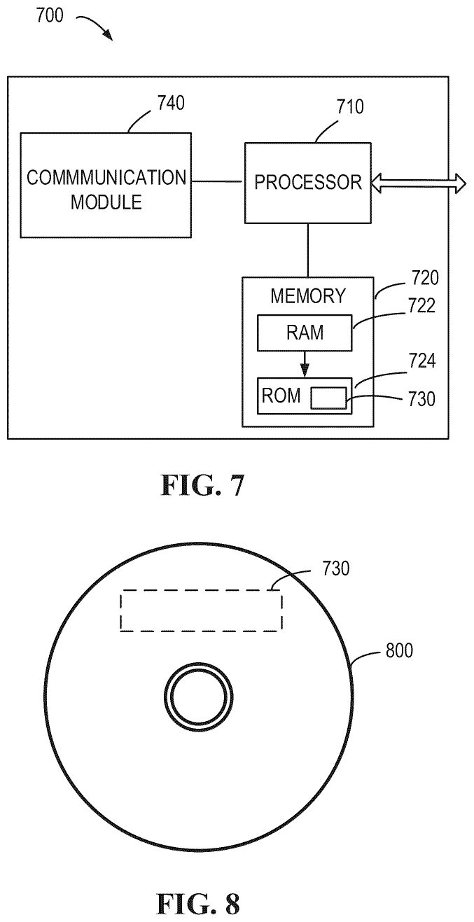

FIG. 7 is a simplified block diagram of a device 700 that is suitable for implementing example embodiments of the present disclosure. The device 700 may be provided to implement a communication device, for example, the first apparatus 110 or the second apparatus 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus to:
receive, from a second apparatus, a first set of reference signals and a second set of reference signals different from the first set of reference signals;
generate a predicted result for a first time period based on the first set of reference signals;
generate a measured result for the first time period based on the second set of reference signals; and
transmit the predicted result and the measured result to the second apparatus.

2. The first apparatus of claim 1, wherein the second set of reference signals are precoded with a signal characteristic unknown to the first apparatus.

3. The first apparatus of claim 2, wherein the signal characteristic comprises at least one of:
a pseudo random phase, or
a pseudo random amplitude.

4. The first apparatus of claim 1, wherein the second set of reference signals are received within the first time period, and
the first set of reference signals are received within a second time period different from the first time period.

5. The first apparatus of claim 1, wherein the first set of reference signals are allocated with a first resource element, and
the second set of reference signals are allocated with a second resource element different from the first resource element.

6. The first apparatus of claim 5, wherein the first set of reference signals are transmitted with a zero power within the first time period, and
the second set of reference signals are transmitted with a non-zero power within the first time period.

7. The first apparatus of claim 5, wherein the first resource element and the second resource element are adjacent within a physical resource block.

8. The first apparatus of claim 1, wherein the instructions, when executed by the at least one processor, cause the first apparatus to:
receive, from the second apparatus, a configuration for the first set of reference signals and the second set of reference signals.

9. The first apparatus of claim 1, wherein the first apparatus comprises a device under test, and the second apparatus comprises a test equipment, or
the first apparatus comprises a terminal device, and the second apparatus comprises a network device.

10. A second apparatus comprising:
at least one processor; and
at least one memory storing instructions that, when executed by the at least one processor, cause the second apparatus to:
transmit, to a first apparatus, a first set of reference signals and a second set of reference signals different from the first set of reference signals;
receive, from the first apparatus, a predicted result for a first time period and a measured result for the first time period, wherein the predicted result is based on the first set of reference signals, and the measured result is based on the second set of reference signals; and
determine a prediction performance based on the predicted result and the measured result.

11. The second apparatus of claim 10, wherein the instructions, when executed by the at least one processor, cause the second apparatus to:
precode the second set of reference signals with a signal characteristic unknown to the first apparatus.

12. The second apparatus of claim 11, wherein the signal characteristic comprises at least one of:
a pseudo random phase, or
a pseudo random amplitude.

13. The second apparatus of claim 11, wherein the instructions, when executed by the at least one processor, cause the second apparatus to:
update the measured result based on the signal characteristic; and
generate the prediction performance by comparing the updated measured result and the predicted result.

14. The second apparatus of claim 10, wherein the second set of reference signals are transmitted within the first time period, and
the first set of reference signals are transmitted within a second time period different from the first time period.

15. The second apparatus of claim 10, wherein the first set of reference signals are allocated with a first resource element, and
the second set of reference signals are allocated with a second resource element different from the first resource element.

16. The second apparatus of claim 15, wherein the first set of reference signals are transmitted with a zero power within the first time period, and
the second set of reference signals are transmitted with a non-zero power within the first time period.

17. The second apparatus of claim 15, wherein the first resource element and the second resource element are adjacent within a physical resource block.

18. The second apparatus of claim 10, wherein the instructions, when executed by the at least one processor, cause the second apparatus to:
transmit, to the first apparatus, a configuration for the first set of reference signals and the second set of reference signals.

19. The second apparatus of claim 10, wherein the first apparatus comprises a device under test, and the second apparatus comprises a test equipment, or
the first apparatus comprises a terminal device, and the second apparatus comprises a network device.

20. A method comprising:
receiving, at a first apparatus from a second apparatus, a first set of reference signals and a second set of reference signals different from the first set of reference signals;
generating a predicted result for a first time period based on the first set of reference signals;
generating a measured result for the first time period based on the second set of reference signals; and
transmitting the predicted result and the measured result to the second apparatus.

21. A method comprising:
transmitting, at a second apparatus to a first apparatus, a first set of reference signals and a second set of reference signals different from the first set of reference signals;
receiving, from the first apparatus, a predicted result for a first time period and a measured result for the first time period, wherein the predicted result is based on the first set of reference signals, and the measured result is based on the second set of reference signals; and
determining a prediction performance based on the predicted result and the measured result.
